(19) United States
(12) Patent Application Publication
(10) Pub. No.: US 2006/0018245 A1
(43) Pub. Date: Jan. 26, 2006

(54) Image data display on an information carrier

(75) Inventors: Alphons Antonius Maria Lambertus Bruekers, Eindhoven (NL); Antonius Hermanus Maria Akkermans, Eindhoven (NL); Josephus Arnoldus Henricus Maria Kahlman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/537,138

(22) PCT Filed: Nov. 28, 2003
(86) PCT No.: PCT/IB03/05549

§ 371 Date: Jun. 2, 2005

(30) Foreign Application Priority Data
Dec. 4, 2002 (EP) 02292997.0

(51) Int. Cl. G11B 7/24

(52) U.S. Cl. 369/275.1

(57) ABSTRACT

The invention relates to an information carrier (101) intended to be put into a rotary motion, said information carrier (101) comprising: -display means (102) for displaying image data, -motion -compensation means (103) applied to said image data for motion-compensating said rotary motion. Use: Optical disc/Optical disc player.

### FIELD OF THE INVENTION

The invention relates to an information carrier intended to be put into a rotary motion.

The invention also relates to a player apparatus for playing such an information carrier.

The invention may be used in the field of optical discs for displaying a still image on an optical disc in a player apparatus.

### BACKGROUND OF THE INVENTION

Information carriers such as optical discs comprise visual data mapped on the surface opposite to the reading surface. In particular, visual data may correspond to the label of the record or the table of contents (TOC). These data are only visible to a user when the disc is not rotating.

The Japanese Patent published under number 11-250644 describes a disc player comprising means which allow to see the label of a disc when rotating. To this end, the player comprises means for flashing a label face once per revolution so that the label can be seen as an apparently still image in that the afterimage is made continuous. The property of the human eye to integrate visual information is used here.

The disc player as described in the prior art document has technical limitations.

The use of flashing means takes up a lot a space in the player, so that this solution cannot be used in consumer products such as disc players of reduced size.

Moreover, flashing means are power consuming.

Finally, using flashing means only displays an image that was previously printed on the disc.

### OBJECT AND SUMMARY OF THE INVENTION

It is an object of the invention to propose an information carrier that can display an apparently still image when rotating. To this end, the information carrier comprises:
display means for displaying image data,
motion-compensation means applied to said image data for motion-compensating said rotary motion.

The motion-compensation is capable of cancelling the effect of the rotation, so that the displayed image appears to be still to a user looking at the disc player apparatus. Means for obtaining an apparently still image are directly put on the disc itself Thus, such a solution no longer needs flashing means, which allows to reduce the size of a player apparatus intended to play an information carrier according to the invention.

In a preferred embodiment, the information carrier comprises a memory device for storing said image data.

This memory device can store image data concerning the information carrier such as, for example, the disc label, the TOC, or an image of the performer.

In a preferred embodiment, the information carrier comprises contactless means for receiving said image data from an information carrier player apparatus.

This feature allows a user to personalize and to change the content of the displayed image on the disc. For example, a CD audio information carrier may receive colored patterns that change in accordance with the music, or any image data (or a sequence of image data) sent by the player apparatus.

In a preferred embodiment, the information carrier comprises calculation means for calculating the angular position of the information carrier and/or contactless means for receiving said angular position from an information carrier player apparatus.

The angular position of the display means is used for periodically performing the motion-compensation of image data so as to ensure an apparently still image.

If the calculation means for calculating the angular position are implemented in the information carrier, the data exchange with the player apparatus is limited, which allows to decrease the complexity of such an apparatus. Moreover, it eases the use of information carriers according to the invention in existing player apparatuses.

If the calculation means for calculating the angular position are implemented in the player apparatus, the cost of information carriers according to the invention is reduced.

In a preferred embodiment, the display means correspond to a pixel matrix arranged in a rectangular pattern.

In a preferred embodiment, the display means correspond to a pixel matrix arranged in a circular pattern.

In a preferred embodiment, the display means are formed by a polymer LED display.

These displays can reproduce the content of image data while ensuring an easy addressing and/or a small thickness of the information carrier. If these displays correspond to LED displays (Light Emitting Diodes), or to LCD (Liquid Crystal Display), the power consumption is reduced significantly.

The invention also relates to an information carrier player apparatus comprising contact-less means for sending image data to an information carrier as described above.

In a preferred embodiment, the player apparatus comprises calculation means for calculating the angular position of said information carrier, said angular position being sent to said information carrier by said contactless means.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts an information carrier according to the invention,

FIG. 2 depicts the processing means implemented in an information carrier according to the invention, and the processing means implemented in the player apparatus according to the invention in which the information carrier is intended to be inserted,

FIG. 3A depicts an information carrier according to the invention with a first type of display,

FIG. 3B depicts an information carrier according to the invention with a second type of display.

### DETAILED DESCRIPTION OF THE INVENTION

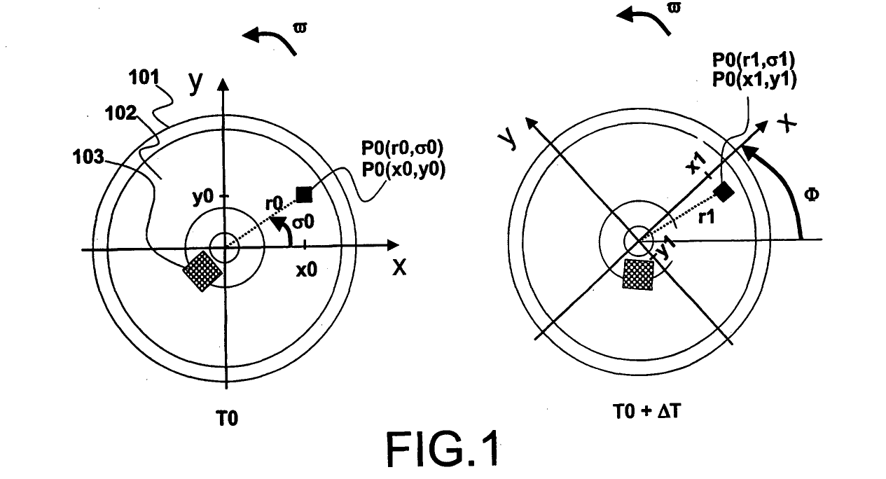

FIG. 1 depicts the structure of an information carrier 101 according to the invention, said information carrier being intended to be put into rotation. This information carrier corresponds, for example, to a CD Audio, a DVD, or any other optical disc.

The information carrier 101 comprises display means 102 for displaying digital image data. The display means 102, interdependent with the information carrier 101, are mapped on a surface of the information carrier 101 so that the reading operation performed by a laser beam is not disturbed.

The information carrier 101 also comprises motion-compensation means applied to image data for periodically motion-compensating the rotary motion. Such motion-compensation means are preferably implemented in an integrated circuit 103 placed in a position where the normal read/write operations of the disc are not disturbed. Advantageously, the integrated circuit is placed-close to the central hole of the information carrier in order to avoid additional mechanical unbalance of the disc and to ease detection (e.g. optically) of the IC positioning (IC in charge of the display). A preferred location is between the information and clamping areas of the information carrier.

The principle of the motion-compensation is to re-compute periodically, during the rotation of the information carrier, the coordinates of pixels (picture elements) composing the image data so that the pixels are apparently displayed at the same spatial coordinates for an external viewer.

For example, let us consider at time T0 the display of pixel value P0 having coordinates (x0,y0) in the reference system (x,y) associated with the display 102. At time (T0+ΔT), considering the rotation of the information carrier at an angular speed of \overline{ω} rad/s, the reference axes (x,y) will have rotated through an angle φ=\overline{ω}.ΔT. The angle φ defines the absolute angular position of the information carrier 101. To display pixel P0 in the same apparent position, a transformation has to be performed on the coordinates (x0,y0) for determining the new coordinates (x1,y1) where the pixel P0 has to be displayed.

This transformation is a rotation through an angle −φ performed on the coordinates (x0,y0) that can be described by the following equations:
x1=int(x0. cos φ+y0. sin φ) Eq. 1
y1=int(y0. cos φ−x0. sin φ) Eq.2
with int(Z) being the nearest integer value of Z, for getting integer coordinates.

This rotation transform may be described more easily if pixels to be displayed are expressed in polar coordinates (r,σ), where r is the radius,.and σ is the angle to axis x. In such a case, the new coordinates (r1,σ1) of pixel PO(r0,σ0) are such that r1=r0, and σ1=σ0−φ.

The motion compensation is advantageously performed to an integer multiple N of the disc rotation frequency, N being set so as to ensure a continuous apparently still image.

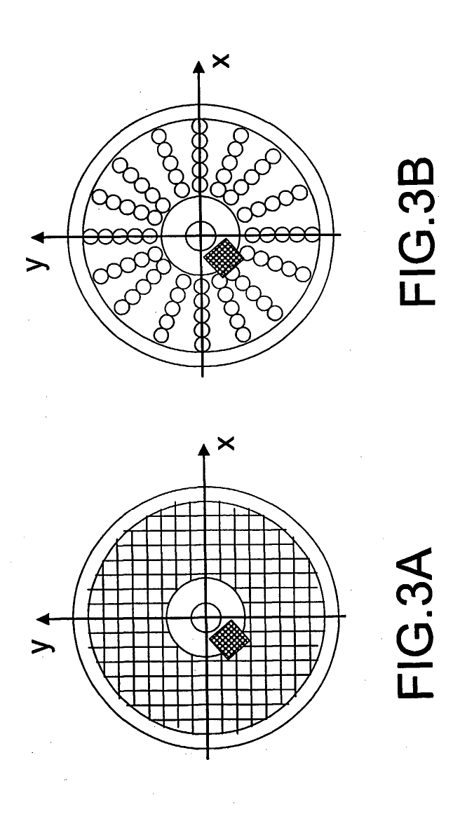

The display 102 may correspond to a pixel matrix arranged in a rectangular pattern, as shown in FIG. 3A.

Advantageously, the display 102 may correspond to a pixel matrix arranged in a circular pattern, such as shown in FIG. 3B (with a limited number of pixel display elements to ease the understanding). This alternative is advantageous because the new pixel coordinates derived from the rotation transform can be directly expressed in polar coordinates, which eases the addressing.

In both cases, the display means 102 are formed by a LED display (light-emitting diode) having the characteristic of being thin, flexible, and of small mass. In particular, the display advantageously is a Polymer LED display known as PolyLED display. A reflective Liquid Crystal Display (LCD) being thin and of small mass may also be used, but must be illuminated externally.

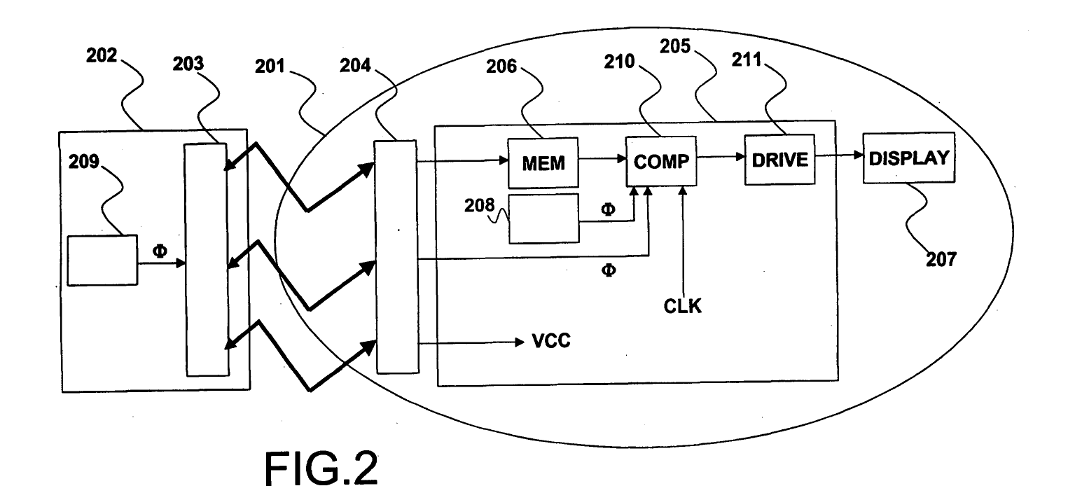

FIG. 2 depicts the processing means implemented in an information carrier 201 according to the invention and processing means implemented in the player apparatus 202 in which the information carrier 201 is intended to be inserted and played.

The information carrier 201 and the player apparatus 202 communicate by contactless means 203 and 204. Contactless means 203 are implemented in the player apparatus, while contactless means 204 are implemented in the integrated circuit 205 (referenced 103 in FIG. 1) and/or at its periphery. Various technological approaches may be used for implementing such contactless means:
inductive approach: using alternating magnetic flux at a few MHz (preferably 13.56 MHz) sent by a coil implemented in the player apparatus and received by a coil implemented in the information carrier,
capacitive approach: using an alternating electrical flux of high voltages and antenna plates in both the information carrier and the player apparatus,
RF (radio frequency) approach: using electro magnetic radiation at high frequencies (a few GHz) with an antenna in the player apparatus, with or without an antenna implemented in the information carrier,
optical coupling approach.

The integrated circuit 205 comprises a memory device 206 for storing the image data to be displayed on the display 207. The image data may be initially stored by the publisher of the information carrier (ROM memory may be advantageously used in this case), or received in real-time by contactless receiving means 203-204 from the player apparatus (RAM memory may be advantageously used in this case). Image data may be stored using either Cartesian or polar coordinates. Image data may be either in a raw format (such as bitmap) or alternatively in a coded format (such as JPEG format). In this latter case, the information carrier comprises decoding means (not represented) for decoding such coded image data.

Image data may correspond, for example, to patterns whose colors change in accordance with the music played, or any other information intended to be looked at by a user (text, images, graphics, sequence of images, updated TOC).

The absolute angular position φ of the information carrier 201 may be determined by calculation means 208 comprised in the chip 205, or alternatively determined by calculation means 209 comprised in the player apparatus. In this latter case, the angular position φ is sent to the information carrier by contactless means 203-204 from the player apparatus. Various technological approaches may be used for determining the absolute angular position φ:
optical detection of the position of the display 207 via the disc read-out spot (optical marker at read side of the information carrier),
from the wobble addresses of the information carrier,
optical detection of the position of the display 207 via extra detection means (optical or magnetic means used as a proximity detector),
using the rotation motor tacho intended to put the information carrier into a rotation,
using a one Pulse Per Rotation signal (1PPO) obtained by on-chip or on-display detection means, e.g. a photo-diode detecting a stationary light spot.

The motion-compensation means 210 are applied to image data stored in memory 206. Motion-compensation means 210 correspond in particular to code instructions of a software program executed by a signal processor embedded in the chip 205. The motion-compensation means 210 receive an absolute angular position φ to perform the rotation transform on image pixels to be displayed, as well as a clock signal CLK indicating at which frequency f such a rotation transform has to be performed (f=1/ΔT).

Once all the new coordinates of pixels have been computed by motion-compensation means 210, the pixels are sent to a display driver 211 in charge of driving the display 207 (addressing operation, data buffering . . . ).

The power VCC for all processing and display means implemented in the information carrier 201 is supplied by the contactless means 203-204 or by an on-disc battery.

If the information carrier is not rotating, but is still receiving energy from the contactless means, the image is displayed in a traditional way, that is to say without performing a motion compensation on image data. When the information receives no more energy from the contactless means (i.e. power is removed), it may be advantageous to use a display 207 having the characteristic of retaining the image information. Such a display is known as “electronic paper”.

If the information carrier is fully covered by the display, it may be difficult to see that the information carrier is rotating and that the player apparatus is in a reading or writing mode. It may be advantageous, therefore, to add a visible mark to the information carrier, such as a dot or line shape placed in a certain angular position. When rotating, this mark will appear optically continuous, whereas the mark is clearly visible on the information carrier when the display is switched off.

1. Information carrier (101) intended to be put into a rotary motion, said information carrier (101) comprising:
display means (102) for displaying image data,
motion-compensation means (103) applied to said image data for motion-compensating said rotary motion.

2. Information carrier as claimed in claim 1, comprising a memory device (206) for storing said image data.

3. Information carrier as claimed in claim 2, comprising contactless means (204) for receiving said image data from an information carrier player apparatus (202).

4. Information carrier as claimed in claim 3, comprising calculation means (208) for calculating the angular position (φ) of the information carrier (101), or wherein said angular position (φ) is received by said contactless means (204) from said information carrier player apparatus (202).

5. Information carrier as claimed in any one of claims 1 to 4, wherein display means (102) correspond to a pixel matrix arranged in a rectangular pattern.

6. Information carrier as claimed in any one of claims 1 to 4, wherein display means (102) correspond to a pixel matrix arranged in a circular pattern.

7. Information carrier as claimed in any one of claims 1 to 6, wherein display means (102) are formed by a polymer LED display or a LCD display.

8. Player apparatus for playing an information carrier, said player apparatus comprising contactless means (203) for sending image data to an information carrier as claimed in claim 1.

9. Player apparatus as claimed in claim 8, comprising calculation means (209) for calculating the angular position (φ) of said information carrier, said angular position being sent to said information carrier by said contactless means (203).
